(19) United States
(12) Patent Application Publication
(10) Pub. No.: US 2004/0118298 A1
(43) Pub. Date: Jun. 24, 2004

(54) Coffee making machine

(75) Inventor: William Kwok Kay Lee, Kwun Tong (HK)

Correspondence Address: LEYDIG VOIT & MAYER, LTD, 700 THIRTEENTH ST. NW, SUITE 300, WASHINGTON, DC, 20005-3960, US

(73) Assignee: Main Power Electrical Factory Ltd., Kwun Tong (HK)

(21) Appl. No.: 10/321,389

(22) Filed: Dec. 18, 2002

(51) Int. Cl. A23F 3/00

(52) U.S. Cl. 99/280

(57) ABSTRACT

A coffee making machine includes a water reservoir, a heating element, a controller programmed to analyse data and generate a signal for the heating element. A relay circuit controls current to the heating element. A temperature sensor monitors heat at the heating element and a water level switch detects water level in the reservoir. If the temperature sensor detects excessive temperature at the heating element, the controller transmits a disable signal to the relay circuit to thereby stop any current to the heating element. If the water level switch detects a low water level in the reservoir, the controller transmits a signal to the control panel to thereby disable the starting of brewing cycle. A display panel displays an operational mode of the machine and the user can't start the machine in any “Run Mode” when either a high temperature or low water condition is determined.

### FIELD OF THE INVENTION

The present invention relates generally to household appliances having an electronic control system. More particularly, although not exclusively, the invention relates to a coffee making machine having a special control system to operate the coffee maker automatically at a pre-set time.

The invention also relates to a coffee machine having a water reservoir and means for detecting the water level therein, in which a microprocessor can activate the machine only if a high water level is detected. This can prevent the coffee maker being repeatedly activated at a pre-set daily time when there is insufficient water in the reservoir.

### OBJECTS OF THE INVENTION

It is an object of the present invention to provide a coffee making machine that can be activated automatically at a pre-set time only if there is sufficient water in the water reservoir.

Another object is to provide a coffee making machine having a water reservoir and a switch for detecting a low water level in the reservoir and thereby cause the machine to display or sound a warning signal.

### DISCLOSURE OF THE INVENTION

There is disclosed herein a coffee making machine comprising:

a water reservoir,

a heating element,

a controller programmed to analyse data and generate a signal for the heating element,

a relay circuit for controlling current to the heating element,

a temperature sensor for monitoring heat at the heating element,

a water level switch for detecting water level in the reservoir, the switch comprising:

a reed switch and a floating magnet constrained to move within a vertical tube inside the reservoir and positioned alongside the reed switch, wherein

the controller is programmed to check the water level switch before starting a brewing cycle and if a low water level is detected, the controller transmits a disable signal to the control panel to prevent starting of the brewing cycle.

The preferred embodiment of the machine includes a microprocessor and an electronic timer, that can activate the machine at a pre-set time.

There might be warning signals associated with a low water condition. The microprocessor might sound or display a warning signal if the coffee making machine is unattended for too long, or the water level drops too low.

Preferably the controller includes a clock registering time of day, an internal register storing a pre-settable activation time whereat the controller generates an activation signal to start brewing.

Preferably the machine further comprises a control panel associated with the controller and having input keys for programming the controller.

Preferably the control panel includes HOUR and MINUTE keys, a PROG key activating the pre-set time required and an ON/OFF(AUTO) key activating a mode wherein an ON mode represents current being delivered to the heating element, an OFF mode represents no current being delivered to said heating element, an AUTO mode represents commencement of current to the heating element at a pre-set time.

Preferably AUTO mode must be retained after a brewing cycle in order for the machine to activate automatically at a pre-set time the following day.

Preferably the machine further comprises an LCD display.

Preferably the LCD displays information including time, activation mode and a low water level icon.

Preferably the controller signals the relay to close the electric circuit to thereby enable current to the heating element when the temperature sensor detects a low temperature in the heating element.

Preferably when the water is above the low water level, the reed switch is closed and when the water is below the low water level, the reed switch is open.

Preferably the canister to receive brewed coffee is in the form of a thermo-flask to keep the brewed coffee warm before consumption.

### BRIEF DESCRIPTION OF THE DRAWINGS

A preferred form of the present invention will now be described by way of example with reference to the accompanying drawings, wherein:

FIG. 1 is a schematic illustration of a coffee making machine including a microprocessor and a water level switch;

FIG. 2 is a schematic circuit diagram; and

FIG. 3 is an electronic connection drawing of coffee making machine.

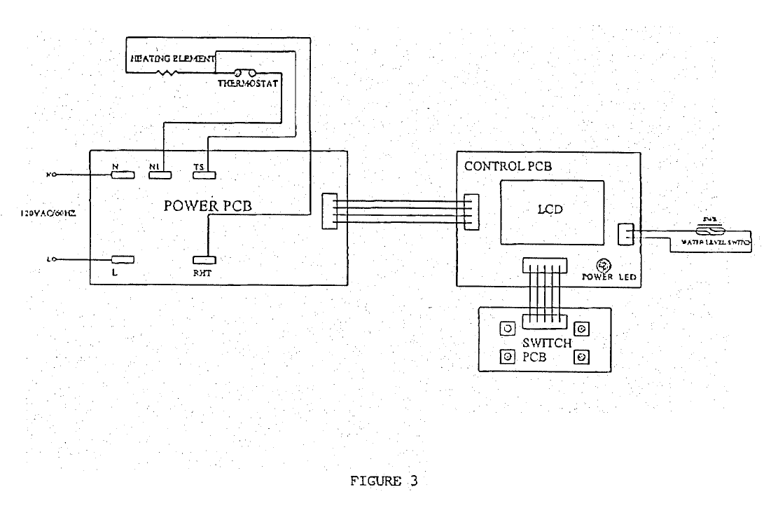

### DESCRIPTION OF THE PREFERRED EMBODIMENT

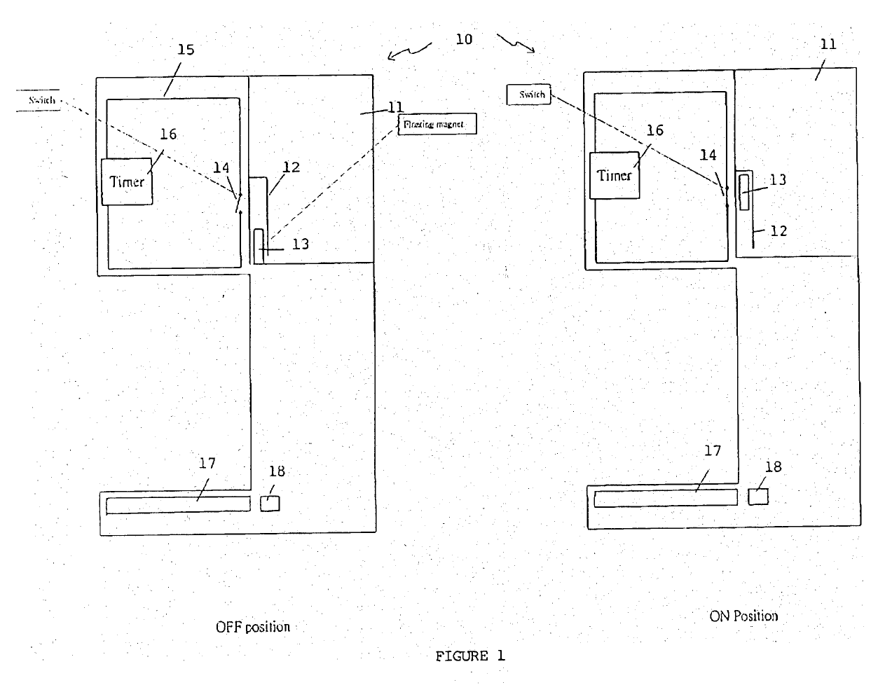

In FIG. 1 of the accompanying drawings there is schematically depicted a coffee making machine 10. The machine 10 includes a reservoir 11 within which there is located a vertical tube 12 that constrains a floating magnet 13. A reed switch 14 is in circuit 15 with a timer 16. The heating element 17 is controlled by the timer and includes a heat sensor 18 also in circuit with the timer 16. A canister (not shown) to receive the brewed coffee is in the form of thermo-flask for keeping the coffee warm.

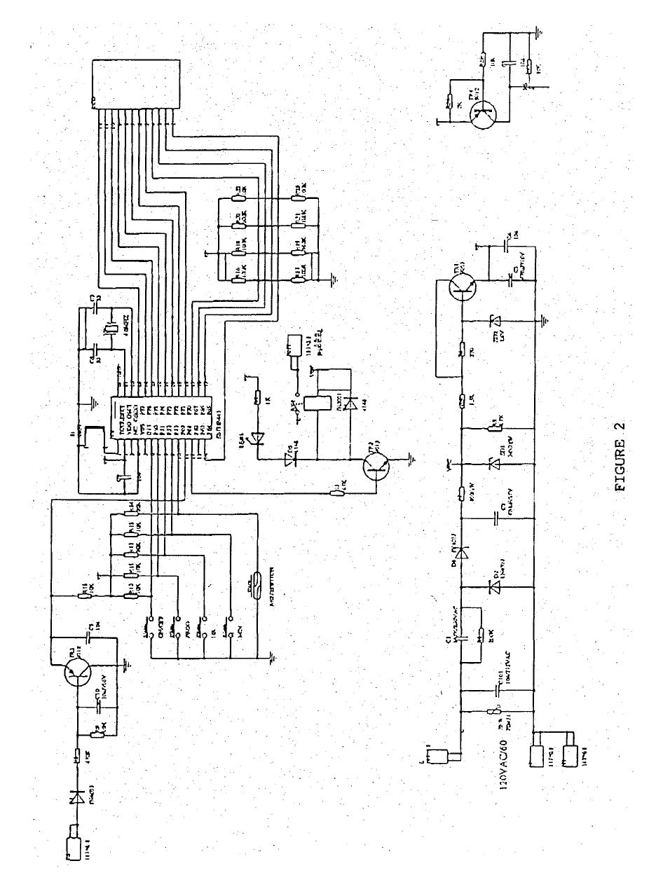

In FIG. 2 there is schematically depicted a circuit diagram applicable for a coffee maker. It includes a power supplying unit, a microprocessor, a relay circuit which is associated electrically with the heating element 17, the LCD display, four user input switches and the reed switch 14.

The alternating voltage is rectified by directional diodes and filtered by a 470 micro-Farad 35 VDC capacitance to provide 24 volts to the relay. A Zener diode limits the voltage to +5 VDC. The +5 VDC is input to the V. sub DD and V. sub SS of microprocessor.

A microprocessor IC1 and an oscillator circuit which includes a 4.00 MHz crystal oscillator XT and capacitor filters to minimise the presence of noise signals in the processing circuit.

When power is supplied thereto for the first time, the microprocessor is reset, then it controls the LCD to display initial time information. At this time the relay is deactivated and there is no pre-set time. In this mode the function buttons SW2, SW3, SW4 can set the time and the pre-set brewing time. All operations will be indicated by the LCD. An internal register registers real time of day and an internal register stores a pre-settable activation time.

The relay circuit interconnects the power supplying unit and the heating element 17. There is a heating indicator that displays an ON mode and goes off in OFF mode. The relay circuit also includes a NPN bipolar transistor TR2 that interconnects the relay RY1 and the microprocessor. When the brewing time coincides with the current time or the device is in ON mode, the transistor TR2 receives a brew enable signal from the microprocessor, and energises the relay RY1 to interconnect electrically the heating element and the power supplying unit in order to heat the water. Each time that the heating element is activated, you can stop it only or reactivate the heating element at a later time.

The thermostat includes a temperature-controlled switch 18 that is connected to the switch circuit and the heating element. The thermostat has a predetermined temperature range, typically of 145° C.±5° C. The temperature-controlled switch opens when the temperature exceeds 150° C. The temperature-controlled switch closes when the temperature drops below 140° C. The input circuit generates a signal which is received by the microprocessor and which corresponds to the status of the switch. If the temperature-controlled switch is open, the microprocessor generates a brewing disable signal to break down transistor TR2, then the relay open so as to cease current flow to the heating element, the brewing cycle is over. If the temperature-controlled switch reverts to close status, but the water reservoir 11 is low, the microprocessor generates a signal to control panel to thereby disable the starting of the brewing cycle even at ON mode. By adding water to the reservoir 11, the microprocessor transmits signal to control panel at ON mode or at pre-set time of AUTO mode, thereby allows current to be delivered to the heating element and the brewing cycle will start.

At ON mode, if the water reservoir is low on water, the water level switch SWR is off, a high is delivered to the microprocessor. As a response, the LCD will indicate a low-water icon. After adding water a low is delivered to the microprocessor, then the display icon will disappear.

According to above, all signals delivered to the microprocessor are processed by program logic that delivers the corresponding data to the appliance.

It should be appreciated that modifications and alternations obvious to those skilled in the art are not to be considered as beyond the scope of the present invention. For example, for hygienic reasons, it might be advisable not to stop the current to the heating element immediately upon detection of a low water level as some water will remain inside the tubes to the heating element. Delaying the activation of the heating element might exist in evaporating this remaining water. Furthermore, the microprocessor might be adapted to alternatively pre-set the brewing time when water is added to the reservoir that is, there would be no need to press a cycle enable switch.

1. A coffee making machine comprising:
a water reservoir,
a heating element,
a controller programmed to analyse data and generate a signal for the heating element,
a relay circuit for controlling current to the heating element,
a temperature sensor for monitoring heat at the heating element,
a water level switch for detecting water level in the reservoir, the switch comprising:
a reed switch and a floating magnet constrained to move within a vertical tube inside the reservoir and positioned alongside the reed switch, wherein
the controller is programmed to check the water level switch before starting a brewing cycle and if a low water level is detected, the controller transmits a disable signal to the relay circuit to prevent starting of the brewing cycle.

2. The machine of claim 1, wherein the controller includes a clock registering time of day, an internal register storing a pre-settable activation time whereat the controller generates an activation signal to start brewing.

3. The machine of claim 2, further comprising an LCD display.

4. The machine of claim 2, further comprising a control panel associated with the controller and having input keys for programming the controller.

5. The machine of claim 4, wherein the control panel includes HOUR and MINUTE keys, a PROG key and an ON/OFF(AUTO) key activating a mode wherein an ON mode represents current being delivered to the heating element, an OFF mode represents no current being delivered to said heating element, an AUTO mode represents commencement of current to the heating element at a pre-set time.

6. The machine of claim 5, wherein AUTO mode must be retained after a brewing cycle in order for the machine to activate automatically at a pre-set time the following day.

7. The machine of claim 3, wherein the LCD displays information including time, activation mode and a low water level icon.

8. The machine of claim 1, wherein the controller signals the relay to close the electric circuit to thereby enable current to the heating element when the temperature sensor detects a low temperature in the heating element.

9. The machine of claim 1, wherein the water level switch comprises a reed switch and when the water is above the low water level, the reed switch is closed and when the water is below the low water level, the reed switch is open.
